(19) United States
(12) Patent Application Publication
(10) Pub. No.: US 2019/0327630 A1
(43) Pub. Date: Oct. 24, 2019

(54) Method And Apparatus For Measurement Report Enhancement In Mobile Communications

(71) Applicant: MediaTek Inc., Hsinchu City (TW)

(72) Inventors: Yung-Chun Lin, Hsinchu City (TW); Chun-Pin Chen, Hsinchu City (TW); Po-Yu Huang, Hsinchu City (TW)

(21) Appl. No.: 16/392,603

(22) Filed: Apr. 23, 2019

Related U.S. Application Data
(60) Provisional application No. 62/661,226, filed on Apr. 23, 2018.

(51) Int. Cl. H04W 24/10; H04W 8/22

(52) U.S. Cl. CPC H04W 24/10; H04W 8/22

(57) ABSTRACT

Various solutions for measurement report enhancement with respect to user equipment and network apparatus in mobile communications are described. An apparatus may initiate a voice or video call with a network node. The apparatus may determine whether Single Radio Voice Call Continuity before alerting stage (bSRVCC) is supported by the network node. The apparatus may cancel a transmission of a measurement report to the network node before an alerting stage when the bSRVCC is not supported by the network node. The apparatus may perform the voice or video call with the network node.

### CROSS REFERENCE TO RELATED PATENT APPLICATION(S)

The present disclosure is part of a non-provisional application claiming the priority benefit of U.S. patent application Ser. No. 62/661,226, filed on 23 Apr. 2018, the content of which is incorporated by reference in its entirety.

### TECHNICAL FIELD

The present disclosure is generally related to mobile communications and, more particularly, to measurement report enhancement with respect to user equipment and network apparatus in mobile communications.

### BACKGROUND

Unless otherwise indicated herein, approaches described in this section are not prior art to the claims listed below and are not admitted as prior art by inclusion in this section.

In Long-Term Evolution (LTE), Voice over LTE (VoLTE) can be used to establish a voice or video call via the packet switched domain. The voice/video call can be performed over the IP Multimedia Subsystem (IMS) network. However, in certain areas, the LTE coverage or signal quality may not be well. In order to continue the voice/video call in such areas, Single Radio Voice Call Continuity (SRVCC) is introduced to maintain the voice call via the conventional communication networks such as the 2G/3G networks. The data packets of the voice call will be transmitted to the 2G/3G networks. The 2G/3G networks may use the circuit switched domain and/or packet switched domain to convey the data packets of the voice/video call.

However, some IMS networks do not support SRVCC before alerting stage (bSRVCC). Specifically, before entering into the alerting stage, the network or the user equipment (UE) is not allowed to perform the SRVCC. In such network, in an event that the UE makes a mobile-originated (MO) or mobile terminated (MT) call and transmits a measurement report to the network, the network may trigger SRVCC before alerting stage. Since the IMS network does not support the bSRVCC, the MO/MT call will be failed under such scenario. The UE may not be able to establish a voice/video call successfully and the user experience may become bad.

Accordingly, how to avoid call failure when the bSRVCC is not supported by the network may become a new issue in developing a communication system. It is needed to provide proper mechanisms to report measurement reports for avoiding call failure due to network capabilities.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to measurement report enhancement with respect to user equipment and network apparatus in mobile communications.

In one aspect, a method may involve an apparatus initiating a voice/video call with a network node. The method may also involve the apparatus determining whether bSRVCC is supported by the network node. The method may further involve the apparatus cancelling a transmission of a measurement report to the network node before an alerting stage when the bSRVCC is not supported by the network node. The method may further involve the apparatus performing the voice/video call with the network node.

In one aspect, an apparatus may comprise a transceiver capable of wirelessly communicating with a network node of a wireless network. The apparatus may also comprise a processor communicatively coupled to the transceiver. The processor may be capable of initiating, via the transceiver, a voice/video call with the network node. The processor may also be capable of determining whether bSRVCC is supported by the network node. The processor may further be capable of cancelling a transmission of a measurement report to the network node before an alerting stage when the bSRVCC is not supported by the network node. The processor may further be capable of performing, via the transceiver, the voice/video call with the network node.

It is noteworthy that, although description provided herein may be in the context of certain radio access technologies, networks and network topologies such as Global System for Mobile Communications (GSM), Universal Mobile Telecommunications System (UMTS), Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to measurement report enhancement with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In LTE, VoLTE can be used to establish a voice/video call via the packet switched domain. The voice/video call can be performed over the IMS network. However, in certain areas, the LTE coverage or signal quality may not be well. In order to continue the voice/video call in such areas, SRVCC is introduced to maintain the voice/video call via the conventional communication networks such as the 2G/3G networks. The data packets of the voice/video call will be transmitted to the 2G/3G networks. The 2G/3G networks may use the circuit switched domain and/or packet switched domain to convey the data packets of the voice/video call. Accordingly, the voice/video call may be continued without failure.

However, some IMS networks do not support bSRVCC. Specifically, before entering into the alerting stage, the network or the UE is not allowed to perform the SRVCC. In such network, in an event that the UE makes a MO or MT call and transmits a measurement report to the network, the network may trigger SRVCC before alerting stage. Since the IMS network does not support the bSRVCC, the MO/MT call will be failed under such scenario. The UE may not be able to establish a voice/video call successfully and the user experience may become bad.

In view of the above, the present disclosure proposes a number of schemes pertaining to establish a voice/video call even when the bSRVCC is not supported by the network. When the bSRVCC is not supported by the network, some schemes may be adopted the UE to avoid triggering the bSRVCC. The UE may be configured not to transmit a measurement report to the network or transmit an allowed measurement report to the network. With proper measurement report enhancement, the bSRVCC may not be triggered by the network. Accordingly, the voice/video call may be established successfully even when the bSRVCC is not supported by the network. The UE may have better performance and the user experience may be improved.

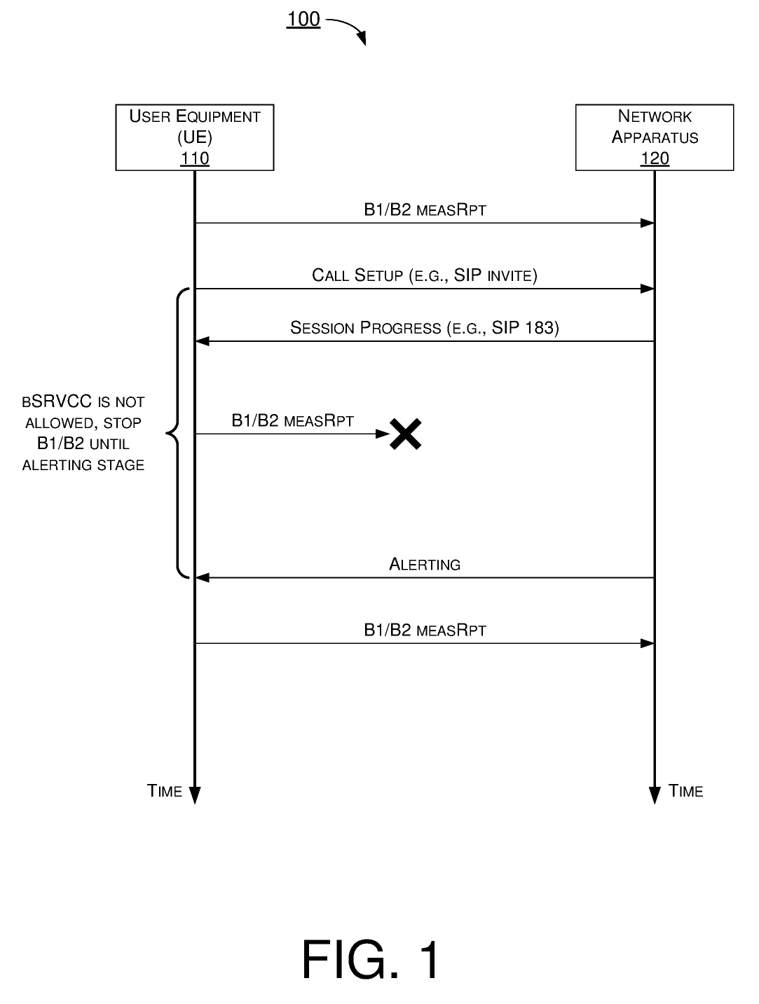

FIG. 1 illustrates an example scenario 100 under schemes in accordance with implementations of the present disclosure. Scenario 100 involves UE 110 and network apparatus 120, which may be a part of a wireless communication network (e.g., an LTE network, an LTE-Advanced network, an LTE-Advanced Pro network, a 5G network, an NR network, an IoT network or an NB-IoT network). After establishing a connection with network apparatus 120, UE 110 may be configured to transmit a measurement report to network apparatus 120. The measurement report may comprise, for example and without limitation, a B1 measurement report or a B2 measurement report. When UE 110 is configured to initiate a voice/video call (e.g., MO call), UE 110 may be configured to transmit a call setup message (e.g., SIP invite) to network apparatus 120. After receiving the call setup message, network apparatus 120 may be configured to transmit a session progress message (e.g., SIP 183) to UE 110. The session progress message may carry a capability indication to inform UE 110 whether the bSRVCC is supported by network apparatus 120. UE 110 may be configured to determine whether the bSRVCC is supported by network apparatus 120 according to the capability indication received from network apparatus 120. For example, UE 110 may be configured to check whether “+g.3gpp.ps2cs-srvcc-orig-pre-alerting” information in “Feature-Caps” filed is present in message “SIP 183 Session Progress”. In some implementations, the capability indication may also be carried in other message transmitted from network apparatus 120 to UE 110. In some implementations, the capability information may also be provided to UE 110 by any other mechanisms such as, for example and without limitation, a pre-defined setting (e.g., service agreement), a dynamic update (e.g., registration), a learning mechanism, or an information sharing mechanism.

In an event that the capability indication indicate that the bSRVCC is not supported by network apparatus 120, UE 110 may be configured to cancel a transmission of a measurement report to network apparatus 120 before an alerting stage. The cancelling may comprise, for example and without limitation, postponing, stopping, deleting, etc. For example, UE 110 may be configured not to transmit any B1 and/or B2 measurement report to network apparatus 120 before the alerting stage. The UE may be configured to transmit the B1 measurement report when an inter radio access technology (RAT) neighbor becomes better than a threshold. The UE may be configured to transmit the B2 measurement report when a primary cell (PCell) becomes worse than a threshold 1 and an inter RAT neighbor becomes better than a threshold 2. Accordingly, once UE 110 does not transmit any B1 and/or B2 measurement report to network apparatus 120, the SRVCC may not be triggered before the alerting stage. Therefore, the bSRVCC may be avoided and the voice/video call may not be failed.

UE 110 may receive an alerting message from network apparatus 120 when entering the alerting stage. After receiving the alerting message, UE 110 may be configured to transmit the B1 and/or B2 measurement report to network apparatus 120. During the alerting stage, the SRVCC is supported by network apparatus 120. UE 110 may be able to transmit any measurement report to network apparatus 120. Then, UE 110 may be able to perform the voice/video call with network apparatus 120.

In some implementations, UE 110 may be configured to cancel a transmission of a measurement report to network apparatus 120 before an alerting stage according to other reasons. For example and without limitation, in an event that the signal quality or strength of a serving cell is good enough (e.g., higher than the network configured threshold1 for B2 and/or higher than a threshold value determined by UE 110), UE 110 may be configured not to transmit a measurement report to network apparatus 120.

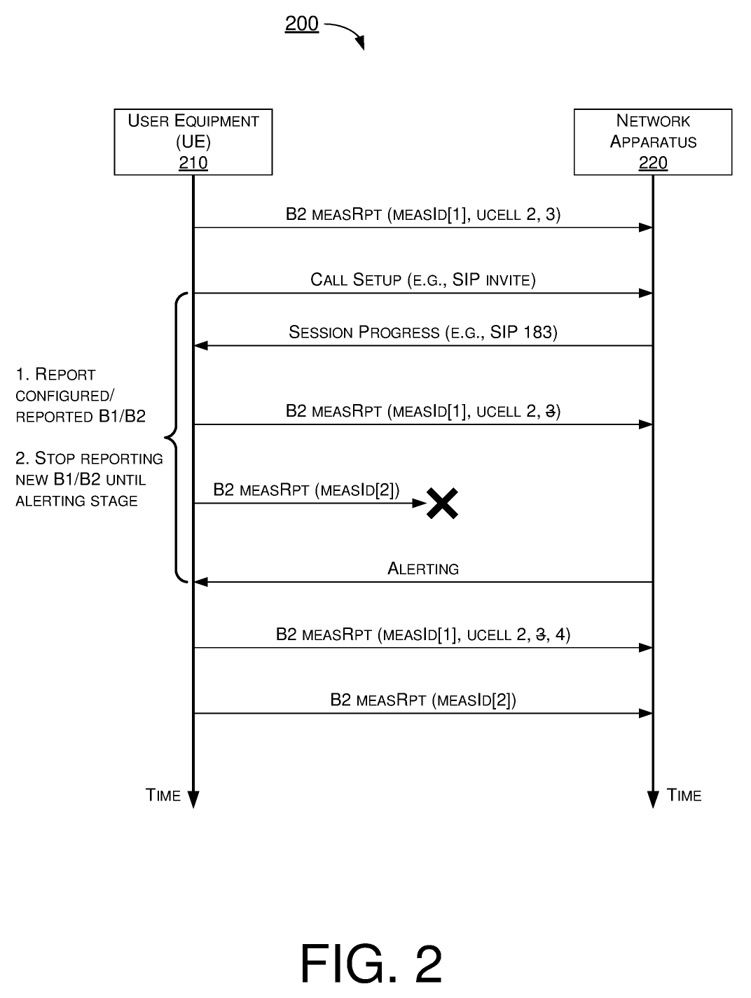

FIG. 2 illustrates an example scenario 200 under schemes in accordance with implementations of the present disclosure. Scenario 200 involves UE 210 and network apparatus 220, which may be a part of a wireless communication network (e.g., an LTE network, an LTE-Advanced network, an LTE-Advanced Pro network, a 5G network, an NR network, an IoT network or an NB-IoT network). After establishing a connection with network apparatus 220, UE 210 may be configured to transmit a measurement report to network apparatus 220. The measurement report may comprise, for example and without limitation, a B1 measurement report or a B2 measurement report. The measurement report may indicate a measurement identification (ID) (e.g., measId[1]) and the associated UMTS cells (e.g., ucell 2, 3). When UE 210 is configured to initiate a voice/video call (e.g., MO call), UE 210 may be configured to transmit a call setup message (e.g., SIP invite) to network apparatus 220. After receiving the call setup message, network apparatus 220 may be configured to transmit a session progress message (e.g., SIP 183) to UE 210. The session progress message may carry a capability indication to inform UE 210 whether the bSRVCC is supported by network apparatus 220. UE 21 may be configured to determine whether the bSRVCC is supported by network apparatus 220 according to the capability indication received from network apparatus 220.

In scenario 200, after determining that the bSRVCC is not supported by network apparatus 220, UE 210 may be configured to transmit an allowed measurement report to network apparatus 220 before the alerting stage. Specifically, the allowed measurement report may comprise a measurement report configured or reported before the initiation of the voice/video call. For example, the allowed measurement report may comprise the B1 and/or B2 measurement report which is configured to UE 210 or reported by UE 210 before transmitting the call setup message (e.g., SIP invite). UE 210 may be configured to determine whether a measurement report is configured or reported according to a specific measurement ID. For example, the B2 measurement report with measurement ID [1] (e.g., measId[1]) is reported before transmitting the call setup message (e.g., SIP invite). Since such measurement report was reported to network apparatus 220, the bSRVCC may not be triggered and the voice/video call may not be failed. Thus, when a next reporting interval is fulfilled, UE 210 may still be able to transmit the B2 measurement report with measurement ID [1] to network apparatus 220.

In some implementations, no new inter RAT cells may be added to the allowed measurement report even when the report criteria is fulfilled. UE 210 may be configured to cancel an addition of a new cell in the allowed measurement report. The cancelling may comprise, for example and without limitation, postponing, stopping, deleting, etc. For example, a UMTS cell 4 (e.g., ucell 4) is not configured or reported before the initiation of the voice/video call. The measurement report associated with the UMTS cell 4 is not allowed to be added to the allowed measurement report. UE 210 may be configured not to transmit the measurement report associated with the UMTS cell 4 to network apparatus 220 before the alerting stage. The allowed measurement report may solely contain the inter RAT cells that already configured or reported before the initiation of the voice/video call (e.g., ucell 2).

In some implementations, some reported inter RAT cells may be removed from the allowed measurement report when the report criteria is not fulfilled. UE 210 may be configured to remove a cell from the allowed measurement report when a signal quality of the cell is less than a threshold value. For example, when the signal quality or signal strength of the UMTS cell 3 (e.g., ucell 3) becomes bad or lower than a threshold value, UE 210 may be configured to remove the UMTS cell 3 from the allowed measurement report.

To avoid triggering the bSRVCC, a new measurement report that is not configured or reported before the initiation of the voice/video call is not allowed to be transmitted to network apparatus 220. The UE may be configured to stop reporting the new measurement report until the alerting stage. For example, a new B2 measurement report with measurement ID [2] (e.g., measId[2]) is not configured or reported before transmitting the call setup message (e.g., SIP invite). UE 210 may be configured not to transmit the new B2 measurement report with measurement ID [2] to network apparatus 220 before the alerting stage. Accordingly, since UE 210 does not transmit any new measurement report to network apparatus 220, the SRVCC may not be triggered before the alerting stage. Therefore, the bSRVCC may be avoided and the voice/video call may not be failed.

UE 210 may receive an alerting message from network apparatus 220 when entering the alerting stage. After receiving the alerting message, UE 210 may be able to transmit the measurement report that is now allowed to be transmitted before the alerting stage to network apparatus 220. For example, the B2 measurement report associated with the UMTS cell 4 (e.g., ucell 4) may be added and transmitted to network apparatus 220. The new measurement report (e.g., the new B2 measurement report with measurement ID [2]) may also be transmitted to network apparatus 220. During the alerting stage, the SRVCC is supported by network apparatus 220. UE 210 may be able to transmit any measurement report to network apparatus 220. Then, UE 210 may be able to perform the voice/video call with network apparatus 220.

In some implementations, the allowed measurement report may comprise the measurement report that is configured but not reported before the initiation of the voice/video call. Alternatively, the measurement report associated with a new cell may be added to the allowed measurement report. Alternatively, when a report criteria is not fulfilled for a cell (e.g., the signal quality or signal strength of the cell becomes bad or lower than a threshold value), the cell may still be reserved in the allowed measurement report. Alternatively, the allowed measurement report may comprise the B2 measurement report with PCell threshold lower than a specific value. As long as a measurement report may not trigger the bSRVCC, the measurement report may be considered as the allowed measurement report and may be transmitted to the network apparatus before the alerting stage.

In some implementations, UE 210 may be configured to transmit an allowed measurement report to network apparatus 220 before an alerting stage according to other reasons. For example and without limitation, in an event that the signal quality or strength of a serving cell is bad (e.g., lower than the network configured threshold1 for B2 and/or lower than a threshold value determined by UE 110), UE 210 may be configured to transmit an allowed measurement report to network apparatus 220.

In some implementations, the schemes proposed in the present disclosure may be applied to a new generation communication network such as, for example and without limitation, LTE or NR (e.g., 4G/5G network). The SRVCC may be performed via a conventional communication network such as, for example and without limitation, GSM or UMTS (e.g., 2G/3G network). The voice/video call initiated on the new generation communication network (e.g., VoLTE, VoNR) may be handed over to the conventional communication network by the SRVCC technology. The conventional communication network may be able to continue the voice/video call via the circuit switched domain and/or packet switched domain.

### Illustrative Implementations

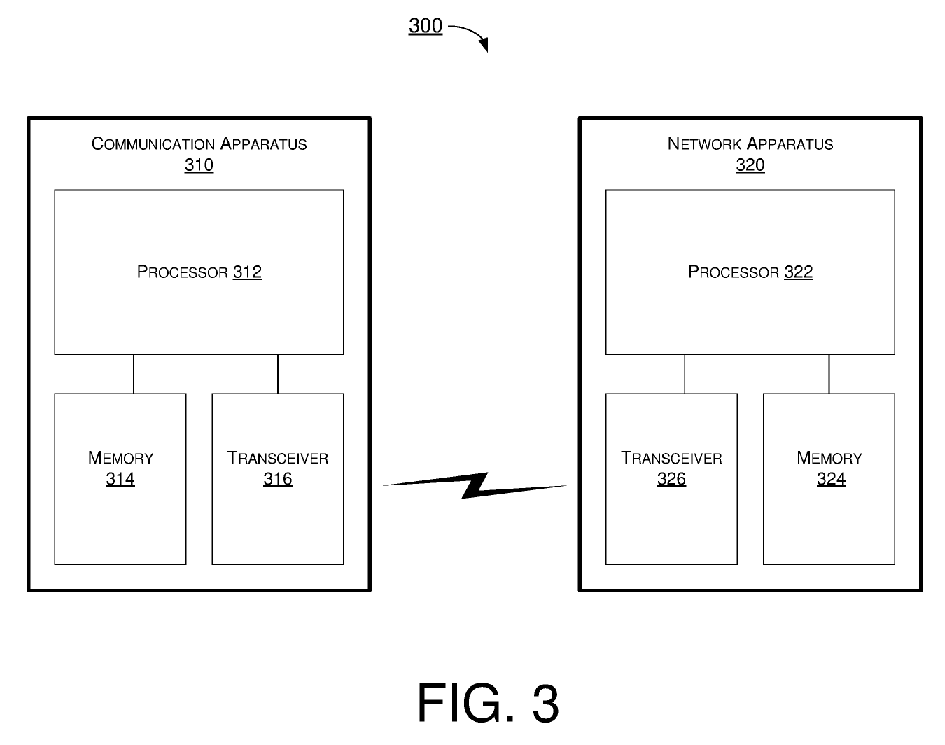

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to measurement report enhancement with respect to user equipment and network apparatus in wireless communications, including scenarios 100 and 200 described above as well as processes 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in a LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, after establishing a connection with network apparatus 320, processor 312 may be configured to transmit, via transceiver 316, a measurement report to network apparatus 320. The measurement report may comprise, for example and without limitation, a B1 measurement report or a B2 measurement report. When processor 312 is configured to initiate a voice/video call (e.g., MO call), processor 312 may be configured to transmit, via transceiver 316, a call setup message (e.g., SIP invite) to network apparatus 320. After receiving the call setup message, processor 322 may be configured to transmit, via transceiver 326, a session progress message (e.g., SIP 183) to communication apparatus 310. The session progress message may carry a capability indication to inform communication apparatus 310 whether the bSRVCC is supported by network apparatus 320. Processor 312 may be configured to determine whether the bSRVCC is supported by network apparatus 320 according to the capability indication received from network apparatus 120. For example, processor 312 may be configured to check whether “+g.3gpp.ps2cs-srvcc-orig-pre-alerting” information in “Feature-Caps” filed is present in message “SIP 183 Session Progress”. In another example, processor 322 may use other messages to carry the capability indication.

In some implementations, in an event that the capability indication indicate that the bSRVCC is not supported by network apparatus 320, processor 312 may be configured to cancel a transmission of a measurement report to network apparatus 320 before an alerting stage. The cancelling may comprise, for example and without limitation, postponing, stopping, deleting, etc. For example, processor 312 may be configured not to transmit any B1 and/or B2 measurement report to network apparatus 320 before the alerting stage.

In some implementations, processor 312 may receive an alerting message from network apparatus 320 when entering the alerting stage. After receiving the alerting message, processor 312 may be configured to transmit the B1 and/or B2 measurement report to network apparatus 320. During the alerting stage, the SRVCC is supported by network apparatus 320. Processor 312 may be able to transmit, via transceiver 316, any measurement report to network apparatus 320. Then, processor 312 may be able to perform, via transceiver 316, the voice/video call with network apparatus 320.

In some implementations, after determining that the bSRVCC is not supported by network apparatus 320, processor 312 may be configured to transmit, via transceiver 316, an allowed measurement report to network apparatus 320 before the alerting stage. Specifically, the allowed measurement report may comprise a measurement report configured or reported before the initiation of the voice/video call. For example, the allowed measurement report may comprise the B1 and/or B2 measurement report which is configured to processor 312 or reported by processor 312 before transmitting the call setup message (e.g., SIP invite). Processor 312 may be configured to determine whether a measurement report is configured or reported according to a specific measurement ID. For example, a B2 measurement report with measurement ID [1] is reported before transmitting the call setup message (e.g., SIP invite). Since such measurement report was reported to network apparatus 320, the bSRVCC may not be triggered and the voice/video call may not be failed. Thus, when a next reporting interval is fulfilled, processor 312 may still be able to transmit the B2 measurement report with measurement ID [1] to network apparatus 320.

In some implementations, processor 312 may be configured to cancel an addition of a new cell in the allowed measurement report. The cancelling may comprise, for example and without limitation, postponing, stopping, deleting, etc. For example, a UMTS cell 4 is not configured or reported before the initiation of the voice/video call. The measurement report associated with the UMTS cell 4 is not allowed to be added to the allowed measurement report. Processor 312 may be configured not to transmit the measurement report associated with the UMTS cell 4 to network apparatus 320 before the alerting stage. Processor 312 may solely report the allowed measurement report containing the inter RAT cells that already configured or reported before the initiation of the voice/video call.

In some implementations, processor 312 may be configured to remove a cell from the allowed measurement report when a signal quality of the cell is less than a threshold value. For example, when the signal quality or signal strength of the UMTS cell 3 becomes bad or lower than a threshold value, processor 312 may be configured to remove the UMTS cell 3 from the allowed measurement report.

In some implementations, a new measurement report that is not configured or reported before the initiation of the voice/video call is not allowed to be transmitted to network apparatus 320. Processor 312 may be configured to stop reporting the new measurement report until the alerting stage. For example, a new B2 measurement report with measurement ID [2] is not configured or reported before transmitting the call setup message (e.g., SIP invite). Processor 312 may be configured not to transmit the new B2 measurement report with measurement ID [2] to network apparatus 320 before the alerting stage. Accordingly, since processor 312 does not transmit any new measurement report to network apparatus 320, the SRVCC may not be triggered before the alerting stage.

In some implementations, processor 312 may receive, via transceiver 316, an alerting message from network apparatus 320 when entering the alerting stage. After receiving the alerting message, processor 312 may be able to transmit, via transceiver 316, the measurement report that is now allowed to be transmitted before the alerting stage to network apparatus 320. For example, the B2 measurement report associated with the UMTS cell 4 may be added and transmitted to network apparatus 320. Processor 312 may also transmit, via transceiver 316, the new measurement report (e.g., the new B2 measurement report with measurement ID [2]) to network apparatus 320. During the alerting stage, the SRVCC is supported by network apparatus 320. Processor 312 may be able to transmit any measurement report to network apparatus 320. Then, processor 312 may be able to perform, via transceiver 316, the voice/video call with network apparatus 320.

### Illustrative Processes

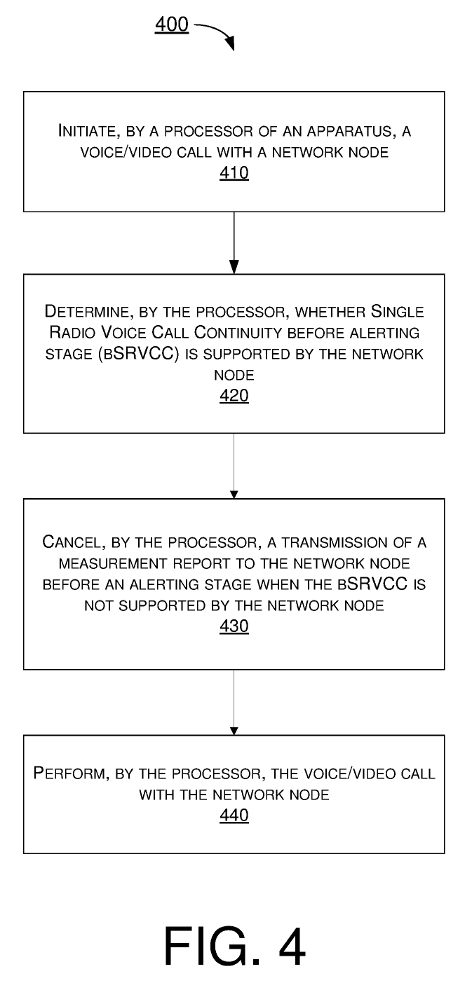

FIG. 4 illustrates an example process 400 in accordance with an implementation of the present disclosure. Process 400 may be an example implementation of scenarios 100 and 200, whether partially or completely, with respect to measurement report enhancement in accordance with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 initiating a voice/video call with a network node. Process 400 may proceed from 410 to 420.

At 420, process 400 may involve processor 312 determining whether bSRVCC is supported by the network node. Process 400 may proceed from 420 to 430. In some implementations, block 420 may be performed before block 410.

At 430, process 400 may involve processor 312 cancelling a transmission of a measurement report to the network node before an alerting stage when the bSRVCC is not supported by the network node. The cancelling may comprise, for example and without limitation, postponing, stopping, deleting, etc. Process 400 may proceed from 430 to 440.

At 440, process 400 may involve processor 312 performing the voice/video call with the network node.

In some implementations, the measurement report may comprise at least one of a B1 measurement report and a B2 measurement report.

In some implementations, process 400 may involve processor 312 transmitting an allowed measurement report to the network node before the alerting stage when the bSRVCC is not supported by the network node.

In some implementations, the allowed measurement report may comprise a measurement report configured before an initiation of the voice/video call.

In some implementations, the allowed measurement report may comprise a measurement report reported before an initiation of the voice/video call.

In some implementations, process 400 may involve processor 312 cancelling an addition of a new cell in the allowed measurement report. The cancelling may comprise, for example and without limitation, postponing, stopping, deleting, etc.

In some implementations, process 400 may involve processor 312 removing a cell from the allowed measurement report when a signal quality of the cell is less than a threshold value.

In some implementations, process 400 may involve processor 312 receiving an alerting message from the network node. Process 400 may further involve processor 312 transmitting the measurement report to the network node after receiving the alerting message.

In some implementations, process 400 may involve processor 312 determining whether the bSRVCC is supported by the network node according to a capability indication received from the network node.

In some implementations, the measurement report may comprise a measurement report not configured or reported before an initiation of the voice/video call.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
initiating, by a processor of an apparatus, a voice/video call with a network node;
determining, by a processor of an apparatus, whether Single Radio Voice Call Continuity before alerting stage (bSRVCC) is supported by the network node;
cancelling, by the processor, a transmission of a measurement report to the network node before an alerting stage when the bSRVCC is not supported by the network node; and
performing, by the processor, the voice/video call with the network node.

2. The method of claim 1, wherein the measurement report comprises at least one of a B1 measurement report and a B2 measurement report.

3. The method of claim 1, further comprising:
transmitting, by the processor, an allowed measurement report to the network node before the alerting stage when the bSRVCC is not supported by the network node.

4. The method of claim 3, wherein the allowed measurement report comprises a measurement report configured before an initiation of the voice/video call.

5. The method of claim 3, wherein the allowed measurement report comprises a measurement report reported before an initiation of the voice/video call.

6. The method of claim 3, further comprising:
cancelling, by the processor, an addition of a new cell in the allowed measurement report.

7. The method of claim 3, further comprising:
removing, by the processor, a cell from the allowed measurement report when a signal quality of the cell is less than a threshold value.

8. The method of claim 1, further comprising:
receiving, by the processor, an alerting message from the network node; and
transmitting, by the processor, the measurement report to the network node after receiving the alerting message.

9. The method of claim 1, wherein the determining comprises determining whether the bSRVCC is supported by the network node according to a capability indication received from the network node.

10. The method of claim 1, wherein the measurement report comprises a measurement report not configured or reported before an initiation of the voice/video call.

11. An apparatus, comprising:
a transceiver capable of wirelessly communicating with a network node of a wireless network; and
a processor communicatively coupled to the transceiver, the processor capable of:
initiating, via the transceiver, a voice/video call with the network node;
determining whether Single Radio Voice Call Continuity before alerting stage (bSRVCC) is supported by the network node;
cancelling a transmission of a measurement report to the network node before an alerting stage when the bSRVCC is not supported by the network node; and
performing, via the transceiver, the voice/video call with the network node.

12. The apparatus of claim 11, wherein the measurement report comprises at least one of a B1 measurement report and a B2 measurement report.

13. The apparatus of claim 11, wherein the processor is further capable of:
transmitting, via the transceiver, an allowed measurement report to the network node before the alerting stage when the bSRVCC is not supported by the network node.

14. The apparatus of claim 13, wherein the allowed measurement report comprises a measurement report configured before an initiation of the voice/video call.

15. The apparatus of claim 13, wherein the allowed measurement report comprises a measurement report reported before an initiation of the voice/video call.

16. The apparatus of claim 13, wherein the processor is further capable of:
cancelling an addition of a new cell in the allowed measurement report.

17. The apparatus of claim 13, wherein the processor is further capable of:
removing a cell from the allowed measurement report when a signal quality of the cell is less than a threshold value.

18. The apparatus of claim 11, wherein the processor is further capable of:
receiving, via the transceiver, an alerting message from the network node; and
transmitting, via the transceiver, the measurement report to the network node after receiving the alerting message.

19. The apparatus of claim 11, wherein, in determining whether the bSRVCC is supported by the network node, the processor is capable of determining whether the bSRVCC is supported by the network node according to a capability indication received from the network node.

20. The apparatus of claim 11, wherein the measurement report comprises a measurement report not configured or reported before an initiation of the voice/video call.
